(19) United States
(12) Patent Application Publication
(10) Pub. No.: US 2026/0147529 A1
(43) Pub. Date: May 28, 2026

(54) AUDIO PLAYBACK IN THE PRESENCE OF MULTIPLE DEVICES

(71) Applicant: QUALCOMM Incorporated, San Diego, CA (US)

(72) Inventors: Shaik Akbar BASHA, Kaikalur (IN); Selvam GOPAL, Rangareddy (IN); Prem Sundar ARUMUGUM, Hyderabad (IN)

(21) Appl. No.: 18/956,758

(22) Filed: Nov. 22, 2024

(51) Int. Cl. G06F 3/16; G04G 21/04

(52) U.S. Cl. CPC G06F 3/165; G06F 3/162; G04G 21/04

(57) ABSTRACT

In some aspects, a user equipment (UE) may send, to an audio device, audio data associated with an audio playback. The UE may send, to a media player user interface associated with a wearable device, an update associated with the audio playback. The UE may receive, from the wearable device, a message indicating that a display screen associated with the wearable device is turned off. The UE may send, to the audio device, an instruction associated with a remote action, wherein the remote action is associated with the audio playback. The UE may refrain from sending, to the media player user interface associated with the wearable device, an update associated with the remote action based at least in part on the message indicating that the display screen is turned off. Numerous other aspects are described.

### FIELD OF THE DISCLOSURE

Aspects of the present disclosure generally relate to wearable devices and, for example, to audio playback in the presence of multiple devices.

### BACKGROUND

A wearable device may refer to an electronic device that is designed to be worn on the body. The wearable device may incorporate sensors and software to track, monitor, and/or interact with a wearer's activities, health, and/or environment. The wearable device may include a smart watch, a fitness tracker, smart glasses, a health monitor, smart clothing, headsets, earbuds, wearable cameras, and other types of similar electronic devices. The wearable device may connect to a smartphone or other systems for enhanced functionality, such as data analysis, notifications, and/or integration with other applications.

### SUMMARY

In some implementations, an apparatus for wireless communication at a user equipment (UE) includes one or more memories; and one or more processors coupled to the one or more memories, the one or more processors individually or collectively configured to cause the UE to: send, to an audio device, audio data associated with an audio playback; send, to a media player user interface associated with a wearable device, an update associated with the audio playback; receive, from the wearable device, a message indicating that a display screen associated with the wearable device is turned off; send, to the audio device, an instruction associated with a remote action, wherein the remote action is associated with the audio playback; and refrain from sending, to the media player user interface associated with the wearable device, an update associated with the remote action based at least in part on the message indicating that the display screen is turned off.

In some implementations, a method of wireless communication performed by a UE includes sending, to an audio device, audio data associated with an audio playback; sending, to a media player user interface associated with a wearable device, an update associated with the audio playback; receiving, from the wearable device, a message indicating that a display screen associated with the wearable device is turned off; sending, to the audio device, an instruction associated with a remote action, wherein the remote action is associated with the audio playback; and refraining from sending, to the media player user interface associated with the wearable device, an update associated with the remote action based at least in part on the message indicating that the display screen is turned off.

In some implementations, a non-transitory computer-readable medium storing a set of instructions for wireless communication includes one or more instructions that, when executed by one or more processors of a UE, cause the UE to: send, to an audio device, audio data associated with an audio playback; send, to a media player user interface associated with a wearable device, an update associated with the audio playback; receive, from the wearable device, a message indicating that a display screen associated with the wearable device is turned off; send, to the audio device, an instruction associated with a remote action, wherein the remote action is associated with the audio playback; and refrain from sending, to the media player user interface associated with the wearable device, an update associated with the remote action based at least in part on the message indicating that the display screen is turned off.

In some implementations, an apparatus for wireless communication includes means for sending, to an audio device, audio data associated with an audio playback; means for sending, to a media player user interface associated with a wearable device, an update associated with the audio playback; means for receiving, from the wearable device, a message indicating that a display screen associated with the wearable device is turned off; means for sending, to the audio device, an instruction associated with a remote action, wherein the remote action is associated with the audio playback; and means for refraining from sending, to the media player user interface associated with the wearable device, an update associated with the remote action based at least in part on the message indicating that the display screen is turned off.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example associated with an audio playback involving multiple devices.

FIG. 2 is a diagram of an example associated with an audio playback involving multiple devices.

FIGS. 3A-3B are diagrams of examples associated with audio playback in the presence of multiple devices.

FIG. 4 is a diagram of an example environment in which systems and/or methods described herein may be implemented.

FIG. 5 is a diagram of example components of one or more devices of FIG. 4.

FIG. 6 is a flowchart of an example process associated with audio playback in the presence of multiple devices.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A user equipment (UE) may be connected to an audio device (e.g., a wireless speaker device, such as a headset or earbuds) and a wearable device (e.g., a smart watch). The UE may perform a remote action on the audio device. The remote action may involve performing an audio playback, pausing the audio playback, adjusting a volume associated with the audio playback, and/or skipping to a next audio track for audio playback. The UE may perform the remote action in conjunction with the audio device. The UE may also send an update to a media player user interface associated with the wearable device based at least in part on the remote action. As part of the update, the UE may send an indication associated with the remote action. The indication may indicate a type of remote action that was performed (e.g., play, pause, track change, or other types of actions). The media player user interface may display the indication of the remote action, which may notify a user of the remote action.

However, the UE may send the update to the wearable device, even when a display screen associated with the wearable device is turned off. In other words, even though the media player user interface may not output the indication of the remote action when the display screen is turned off, the UE may still update the media player user interface in response to the remote action that was performed, which may waste power at the wearable device. The wearable device may receive the indication and process corresponding data to update the media player user interface, even when the display screen is turned off. The wearable device may update the media player user interface as part of a background process. Such processing by the wearable device may not be needed and may unnecessarily consume power without being useful to a user associated with the UE. In other words, the update to the media player user interface may not actually be viewable to the user because the display screen may be turned off. As a result, the UE may unnecessarily waste resources to send the indication to the wearable device and the wearable device may unnecessarily waste resources to process the indication as part of the background process, thereby degrading an overall system performance.

In various aspects of techniques and apparatuses described herein, a UE may be connected to an audio device and a wearable device. The audio device may be responsible for audio playback. During the audio playback, when the wearable device is in a low power state (e.g., when a display screen associated with the wearable device is turned off), the wearable device may notify the UE that the display screen associated with the wearable device is turned off. The wearable device may notify the UE via a message, such as a distributed context fabric (DCF) message or a DCF frame. The message may be in accordance with a DCF protocol. The message may indicate a device display status associated with the wearable device. The message may notify the UE to not send, to the wearable device, which is in the low power mode, any updates regarding remote actions that are performed between the UE and the audio device. The wearable device may not receive any subsequent updates from the UE based at least in part on the message, such that any updates to a media player user interface associated with the wearable device may be avoided, which may save power at the wearable device. The wearable device may be able to remain in a power collapse state, which may save power at the wearable device.

In some aspects, during the audio playback, after the wearable device has returned to a normal power mode (e.g., after the display screen associated with the wearable device is turned on), the wearable device may notify the UE that the display screen associated with the wearable device is turned on. The wearable device may notify the UE via a second message, such as a second DCF message or a second DCF frame. The second message may indicate an updated device display status associated with the wearable device. The second message may notify the UE that the UE is allowed to send, to the wearable device, any subsequent updates regarding remote actions that are performed between the UE and the audio device. The wearable device may receive subsequent updates from the UE based at least in part on the second message. The subsequent updates may cause the media player user interface associated with the wearable device to be updated. In other words, the subsequent updates may cause the wearable device to wake up its processor to process the subsequent updates and update the media player user interface based at least in part on the subsequent updates. If the display screen associated with the wearable device is turned off again, a same procedure may be repeated to save power at the wearable device.

In some aspects, by configuring the wearable device to indicate to the UE when the wearable device is in the low power state (e.g., when the display screen associated with the wearable device is turned off), the UE may not send updates regarding remote actions to the wearable device when the wearable device is in the low power state. In other words, the wearable device may indicate, to the UE, that the display screen is turned off and to not send the updates regarding the remote actions. The UE may refrain from sending such updates, such that the media player user interface is not complied to process the updates, even when the display screen of the wearable device is turned off and the updates are not able to be displayed via the media player user interface. As a result, the UE may save resources may not unnecessarily transmitting the updates to the wearable device, and the wearable device may save resources by not unnecessarily processing the updates, thereby improving an overall system performance.

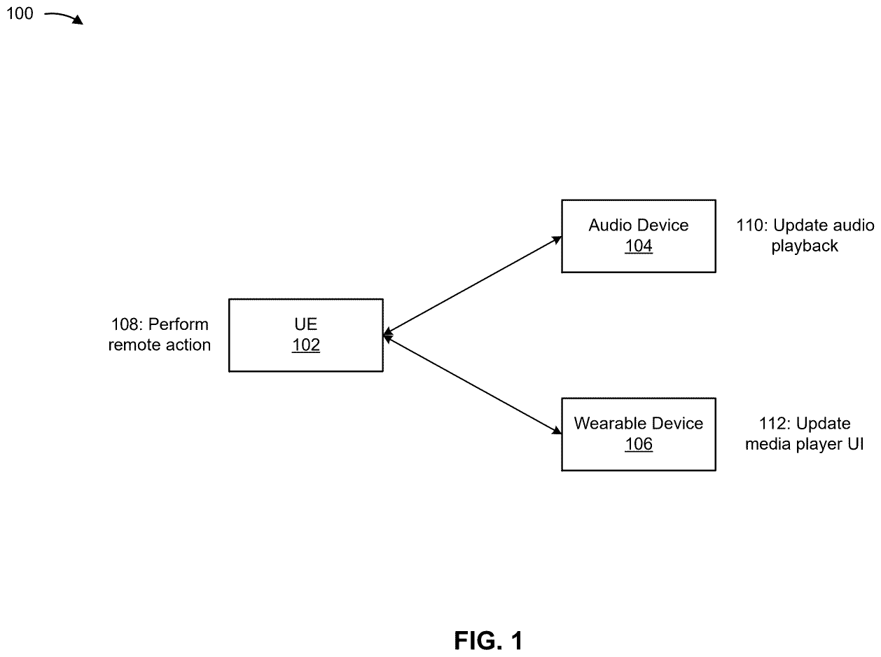

FIG. 1 is a diagram of an example 100 associated with an audio playback involving multiple devices. As shown in FIG. 1, the example 100 includes a UE 102, an audio device 104, and a wearable device 106. The audio device 104 may include a wireless speaker device, such as a headset or earbuds. The wearable device 106 may include a smart watch. The UE 102 and the audio device 104 may be connected to each other, for example, via a Bluetooth connection, a Bluetooth Low Energy (BLE) connection, or an advanced audio distribution profile (A2DP) audio connection. The Bluetooth connection may be a Bluetooth Basic Rate/Enhanced Data rate (BR/EDR) connection. The UE 102 and the wearable device 106 may be connected to each other, for example, via a BLE connection or a Bluetooth connection, such as a BR-EDR asynchronous connection-less (ACL) connection. The UE 102 and the wearable device 106 may be connected to each other via an application that runs on the wearable device 106. The UE 102, the audio device 104, and the wearable device 106 may be associated with an IoT network.

As shown by reference number 108, the UE 102 may receive an instruction to perform a remote action. The UE 102 may receive the instruction via a user interface associated with the UE 102. The remote action may involve playing audio, pausing an audio playback, adjusting a volume associated with the audio playback, and/or skipping to a next audio track for audio playback. The remote action may be an action that is considered to be remote because the remote action may occur at the audio device 104.

As shown by reference number 110, the UE 102 may perform the remote action in conjunction with the audio device 104. For example, in order to play the audio, the UE 102 may send audio data to the audio device 104 for audio playback. In order to pause the audio, the UE 102 may stop sending audio data to the audio device 104, thereby causing a stoppage in the audio playback. In order to adjust the volume, the UE 102 may send an instruction to the audio device 104, and then the audio device 104 may adjust a volume functionality (e.g., instruct a speaker associated with the audio device 104 to output a lower volume or a higher volume) based at least in part on the feedback. In order to skip to the next audio track, the UE 102 may send different audio data to the audio device 104 for audio playback. The UE 102, when performing the remote action, may update an audio playback status on the audio device 104.

As shown by reference number 112, the UE 102 may update a media player user interface (UI) associated with the wearable device 106 based at least in part on the remote action. The UE 102 may send an instruction to the wearable device 106, where the instruction may be associated with the remote action. For example, the instruction may indicate a type of remote action that was performed (e.g., play, pause, track change, or other types of actions). The UE 102 may update the wearable device 106 with the remote action, even when a display screen associated with the wearable device 106 is turned off. In other words, even though the media player user interface may not output an indication of the remote action when the display screen is turned off, the UE 102 may still update the media player user interface in response to the remote action that was performed, which may waste power at the wearable device 106.

In one example, the UE 102 may perform the remote action (e.g., a music related operation), and the remote action may be indicated to the wearable device 106, even when the display screen associated with the wearable device 106 is turned off. In other words, updates by the UE 102 may be cascaded to the wearable device 106, even when the display screen is turned off. When the UE 102 performs the remote action (e.g., play, pause, track change, or other types of actions), the UE 102 may dictate an action to the audio device 104, as well as update same remote actions in the wearable device 106 using Bluetooth or BLE. The wearable device 106 may receive an indication of such remote actions and process corresponding data to update the media player user interface associated with the wearable device 106, even when the display screen is turned off. The wearable device 106 may update the media player user interface as part of a background process. Such processing by the wearable device 106 may not be needed and may unnecessarily consume power without being useful to a user associated with the UE 102. In other words, the update to the media player user interface may not actually be viewable to the user because the display screen may be turned off.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

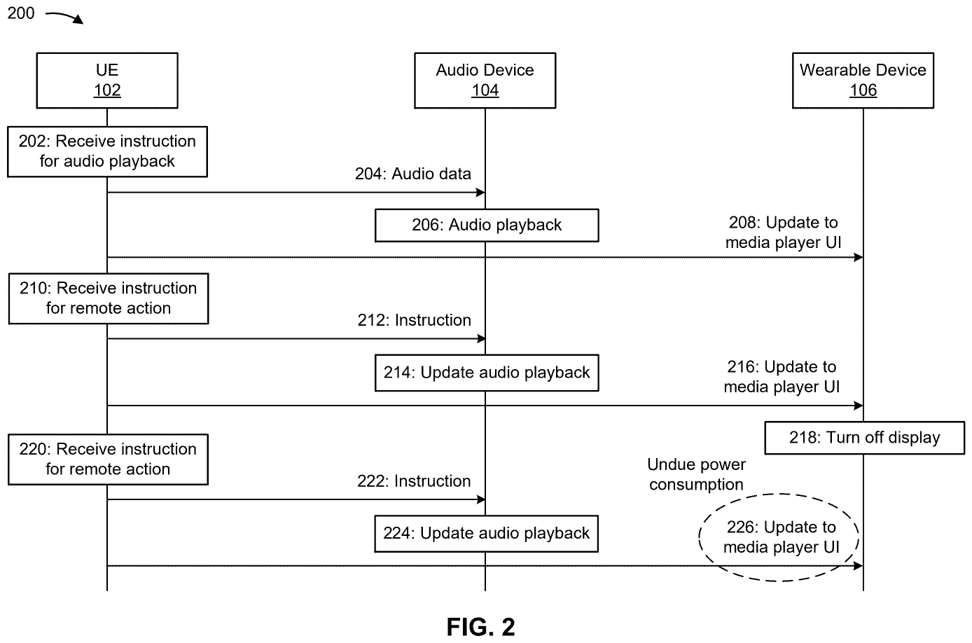

FIG. 2 is a diagram of an example 200 associated with an audio playback involving multiple devices. As shown in FIG. 2, the example 200 includes a UE 102, an audio device 104, and a wearable device 106. The audio device 104 may include a wireless speaker device, such as a headset or earbuds. The wearable device 106 may include a smart watch. The UE 102 and the audio device 104 may be connected to each other, for example, via a Bluetooth connection, a BLE connection, or an A2DP audio connection. The Bluetooth connection may be a BR/EDR connection. The UE 102 and the wearable device 106 may be connected to each other, for example, via a BLE connection or a Bluetooth connection, such as a BR-EDR ACL connection. The UE 102 and the wearable device 106 may be connected to each other via an application that runs on the wearable device 106. In one example, a user (e.g., a same user) may be associated with the UE 102, the audio device 104, and the wearable device 106. The UE 102, the audio device 104, and the wearable device 106 may be associated with an IoT network.

As shown by reference number 202, the UE 102 may receive, via a user interface associated with the UE 102, an instruction for audio playback. The UE 102 may open a media player application and select an audio playlist, which may be based at least in part on instructions received via the user interface. After the media player application is opened and the audio playlist is selected, the UE 102 may receive the instruction for audio playback. As shown by reference number 204, the UE 102 may send audio data to the audio device 104 for audio playback. As shown by reference number 206, the audio device 104 may perform an audio playback based at least in part on the audio data received from the UE 102. As shown by reference number 208, the UE 102 may send, to a media player user interface associated with the wearable device 106, an update regarding the audio playback. The update may indicate an occurrence of the audio playback at the audio device 104. In this example, a display screen associated with the wearable device 106 may be turned on, and the wearable device 106 may display the update via the media player user interface.

As shown by reference number 210, the UE 102 may receive, via the user interface associated with the UE 102, an instruction for a remote action. The remote action may involve pausing the audio playback, stopping the audio playback, adjusting a volume associated with the audio playback, and/or skipping to a next audio track for audio playback. As shown by reference number 212, the UE 102 may send, to the audio device 104, an instruction associated with the remote action. For example, the instruction may be for pausing the audio playback, stopping the audio playback, adjusting the volume associated with the audio playback, and/or skipping to the next audio track for audio playback. As shown by reference number 214, the audio device 104 may update the audio playback, which may be based at least in part on the indication received from the UE 102. As shown by reference number 216, the UE 102 may send, to the wearable device 106, a second update to the media player user interface associated with the wearable device 106. The second update may indicate the remote action performed by the UE 102 and/or the audio device 104. In this example, the display screen associated with the wearable device 106 may be turned on, and the wearable device 106 may display the second update via the media player user interface.

As shown by reference number 218, the wearable device 106 may turn off the display screen, which may be based at least in part on a received input (e.g., from the user associated with the wearable device). As shown by reference number 220, the UE 102 may receive, via the user interface associated with the UE 102, an instruction for a second remote action. The second remote action may involve resuming the audio playback, pausing the audio playback, stopping the audio playback, adjusting the volume associated with the audio playback, and/or skipping to the next audio track for audio playback. As shown by reference number 222, the UE 102 may send, to the audio device 104, an instruction associated with the second remote action. For example, the instruction may be for resuming the audio playback, pausing the audio playback, stopping the audio playback, adjusting the volume associated with the audio playback, and/or skipping to the next audio track for audio playback. As shown by reference number 224, the audio device 104 may update the audio playback, which may be based at least in part on the indication received from the UE 102.

As shown by reference number 226, the UE 102 may send, to the wearable device 106, a third update to the media player user interface associated with the wearable device 106. The third update may indicate the second remote action performed by the UE 102 and/or the audio device 104. In this example, the display screen associated with the wearable device 106 may be turned off, so the wearable device 106 may be unable to display the third update via the media player user interface. In this example, the wearable device 106 may receive the indication of the second remote action and process corresponding data to update the media player user interface associated with the wearable device 106, even when the display screen is turned off. The wearable device 106 may update the media player user interface as part of a background process. Such processing by the wearable device 106 may not be needed and may unnecessarily consume power at the wearable device 106.

In one example, remote actions performed by the UE 102 and/or the audio device 104 may result in unnecessary power consumption at the wearable device 106, even when the display screen at the wearable device 106 is turned off. Every remote action performed by the UE 102 and/or the audio device 104 may be reflected to the wearable device 106 and consume power for a defined wakeup duration. The wakeup duration may be a time taken to process remote action updates from the UE 102. For example, a remote action associated with a volume up may correspond to a power consumption of approximately 20 milliamps (mA) and a wakeup duration of approximately 6 seconds, a remote action of volume down may correspond to a power consumption of approximately 19 mA and a wakeup duration of approximately 6 seconds, a remote action of play music may correspond to a power consumption of approximately 25 mA and a wakeup duration of approximately 4.5 seconds, a remote action of pause music may correspond to a power consumption of approximately 17 mA and a wakeup duration of approximately 6 seconds, and/or a remote action of an automatic audio track change (no manual interaction) may correspond to a power consumption of approximately 40 mA and a wakeup duration of approximately 4 seconds.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

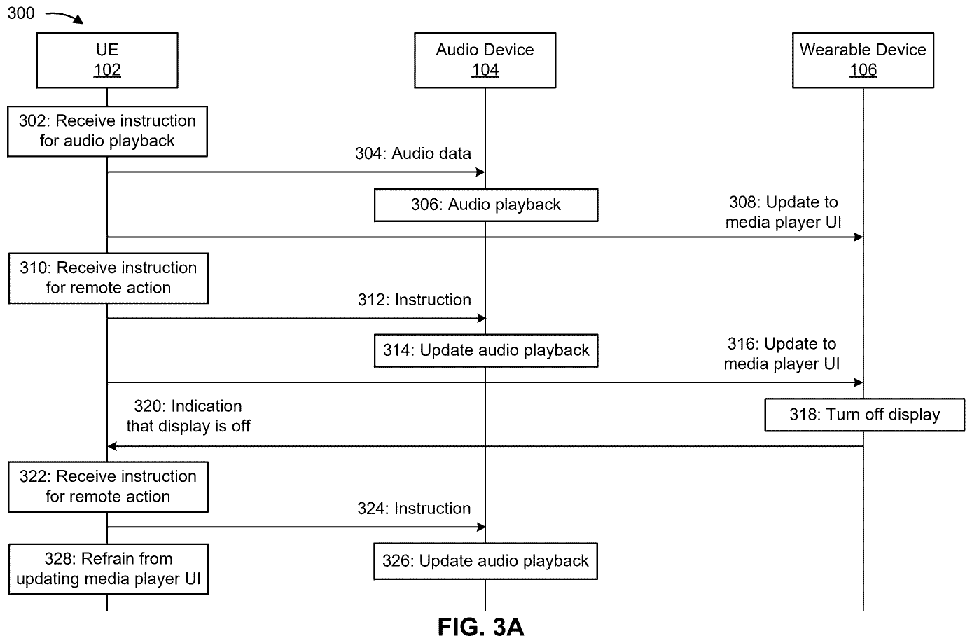

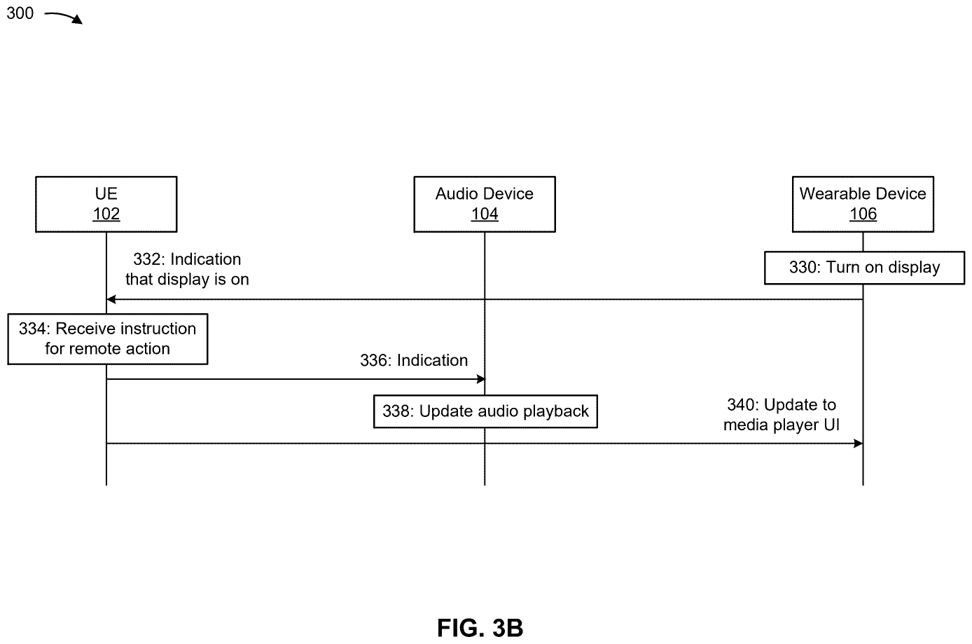

FIGS. 3A-3B are diagrams of examples 300 associated with audio playback in the presence of multiple devices. As shown in FIGS. 3A-3B, the examples 300 include a UE 102, an audio device 104, and a wearable device 106. The audio device 104 may include a wireless speaker device, such as a headset or earbuds. The wearable device 106 may include a smart watch. The UE 102 and the audio device 104 may be connected to each other, for example, via a Bluetooth connection, a BLE connection, or an A2DP audio connection. The Bluetooth connection may be a BR/EDR connection. The UE 102 and the wearable device 106 may be connected to each other, for example, via a BLE connection or a Bluetooth connection, such as a BR-EDR ACL connection. The UE 102 and the wearable device 106 may be connected to each other via an application that runs on the wearable device 106. The UE 102, the audio device 104, and the wearable device 106 may be associated with an IoT network.

As shown in FIG. 3A, and as shown by reference number 302, the UE 102 may receive, via a user interface associated with the UE 102, an instruction for audio playback. The UE 102 may open a media player application and select an audio playlist, which may be based at least in part on instructions received via the user interface. After the media player application is opened and the audio playlist is selected, the UE 102 may receive the instruction for audio playback. As shown by reference number 304, the UE 102 may send audio data to the audio device 104 for audio playback. As shown by reference number 306, the audio device 104 may perform an audio playback based at least in part on the audio data received from the UE 102. As shown by reference number 308, the UE 102 may send, to a media player user interface associated with the wearable device 106, an update regarding the audio playback. The update may indicate an occurrence of the audio playback at the audio device 104. In this example, a display screen associated with the wearable device 106 may be turned on, and the wearable device 106 may display the update via the media player user interface.

As shown by reference number 310, the UE 102 may receive, via the user interface associated with the UE 102, an instruction for a remote action. The remote action may involve pausing the audio playback, stopping the audio playback, adjusting a volume associated with the audio playback, and/or skipping to a next audio track for audio playback. As shown by reference number 312, the UE 102 may send, to the audio device 104, an instruction associated with the remote action. For example, the instruction may be for pausing the audio playback, stopping the audio playback, adjusting the volume associated with the audio playback, and/or skipping to the next audio track for audio playback. As shown by reference number 314, the audio device 104 may update the audio playback, which may be based at least in part on the indication received from the UE 102. As shown by reference number 316, the UE 102 may send, to the wearable device 106, a second update to the media player user interface associated with the wearable device 106. The second update may indicate the remote action performed by the UE 102 and/or the audio device 104. In this example, the display screen associated with the wearable device 106 may be turned on, and the wearable device 106 may display the second update via the media player user interface.

As shown by reference number 318, the wearable device 106 may turn off the display screen, which may be based at least in part on a received input (e.g., from the user associated with the wearable device). As shown by reference number 320, the wearable device 106 may send, to the UE 102 a message to notify the UE 102 that the display screen is turned off. The message may be a DCF message or a DCF frame. The message may indicate a device display status associated with the wearable device 106. The message may notify the UE 102 to not send, to the wearable device 106, any updates regarding remote actions that are performed between the UE 102 and the audio device 104. The message may allow the wearable device 106 to update the device display status associated with the wearable device 106. The message may be useful when the audio playback is running on the UE 102. The message may be sent by the wearable device 106 to the UE 102 to indicate its display status when the wearable device 106 is turned on or turned off. In one example, the message may include a first bit and a second bit. The first bit may be used to indicate a device activate state. The first bit may be set to a first value (e.g., 1) to indicate that the display screen is turned on, or the first bit may be set to a second value (e.g., 0) to indicate that the display screen is turned off. The second bit, when the display screen is turned on, may be set accordingly in order to obtain a current media player status. The UE 102, after receiving the message from the wearable device 106, may update a status of the wearable device 106 to reflect that the display screen has been turned off.

As shown by reference number 322, the UE 102 may receive, via the user interface associated with the UE 102, an instruction for a second remote action. The second remote action may involve resuming the audio playback, pausing the audio playback, stopping the audio playback, adjusting the volume associated with the audio playback, and/or skipping to the next audio track for audio playback. As shown by reference number 324, the UE 102 may send, to the audio device 104, an instruction associated with the second remote action. For example, the instruction may be for resuming the audio playback, pausing the audio playback, stopping the audio playback, adjusting the volume associated with the audio playback, and/or skipping to the next audio track for audio playback. As shown by reference number 326, the audio device 104 may update the audio playback, which may be based at least in part on the indication received from the UE 102.

As shown by reference number 328, the UE 102 may refrain from sending, to the wearable device 106, a third update to the media player user interface associated with the wearable device 106. The UE 102 may refrain from sending the third update based at least in part on the message received from the wearable device 106 indicating that the display screen associated with the wearable device 106 is turned off. The UE 102 may not update the wearable device 106 regarding the second remote action, such that the wearable device 106 may not need to process corresponding data to update the media player user interface associated with the wearable device 106 when the display screen is turned off. As a result, such processing may be avoided by the wearable device 106 and unnecessary power consumption at the wearable device 106 may be avoided.

As shown in FIG. 3B, and as shown by reference number 330, the wearable device 106 may turn on the display screen, which may be based at least in part on a received input (e.g., from the user associated with the wearable device). As shown by reference number 332, the wearable device 106 may send, to the UE 102 a second message to notify the UE 102 that the display screen is turned on. The second message may be a second DCF message or a second DCF frame. The second message may indicate an updated device display status associated with the wearable device 106. The second message may notify the UE 102 that the UE 102 is now able to send, to the wearable device 106, any updates regarding remote actions that are performed between the UE 102 and the audio device 104.

As shown by reference number 334, the UE 102 may receive, via the user interface associated with the UE 102, an instruction for a third remote action. The third remote action may involve resuming the audio playback, pausing the audio playback, stopping the audio playback, adjusting the volume associated with the audio playback, and/or skipping to the next audio track for audio playback. As shown by reference number 336, the UE 102 may send, to the audio device 104, an instruction associated with the third remote action. For example, the instruction may be for resuming the audio playback, pausing the audio playback, stopping the audio playback, adjusting the volume associated with the audio playback, and/or skipping to the next audio track for audio playback. As shown by reference number 338, the audio device 104 may update the audio playback, which may be based at least in part on the indication received from the UE 102. As shown by reference number 340, the UE 102 may send, to the wearable device 106, a third update to the media player user interface associated with the wearable device 106. The third update may indicate the third remote action performed by the UE 102 and/or the audio device 104. In this example, the display screen associated with the wearable device 106 may be turned on, and the wearable device 106 may display the third update via the media player user interface. The UE 102 may send the third update based at least in part on the second message received from the wearable device 106 indicating that the display screen associated with the wearable device 106 is now turned back on.

In some aspects, by configuring the wearable device 106 to indicate to the UE 102 when the display screen associated with the wearable device 106 is turned off, power benefits and other benefits may be achieved. The wearable device 106 may achieve an increased day of usage. As an example, the UE 102 may playback 120 minutes of music per day. During that time frame of 120 minutes, 25 to 30 track changes may occur, 3 to 4 pause/play actions may occur, and 3 to 4 volume up/down actions may occur. Such actions may result in an undue amount of power consumption since the actions may still be processed in a background even though the display screen is turned off. Such actions may translate to approximately 1 to 1.5 hours of usage, which may be saved by avoiding the processing of such actions in the background. Further, unnecessary cascading updates from other devices may be avoided. For example, when multiple devices are added in an IoT network, apart from the UE 102 and the wearable device 106, such cascading updates from the other devices may be avoided, which may decrease complexity and save power at the wearable device 106.

As indicated above, FIGS. 3A-3B are provided as examples. Other examples may differ from what is described with regard to FIGS. 3A-3B. The number and arrangement of devices shown in FIGS. 3A-3B are provided as examples. In practice, there may be additional devices, fewer devices, different devices, or differently arranged devices than those shown in FIGS. 3A-3B. Furthermore, two or more devices shown in FIGS. 3A-3B may be implemented within a single device, or a single device shown in FIGS. 3A-3B may be implemented as multiple, distributed devices. Additionally, or alternatively, a set of devices (e.g., one or more devices) shown in FIGS. 3A-3B may perform one or more functions described as being performed by another set of devices shown in FIGS. 3A-3B.

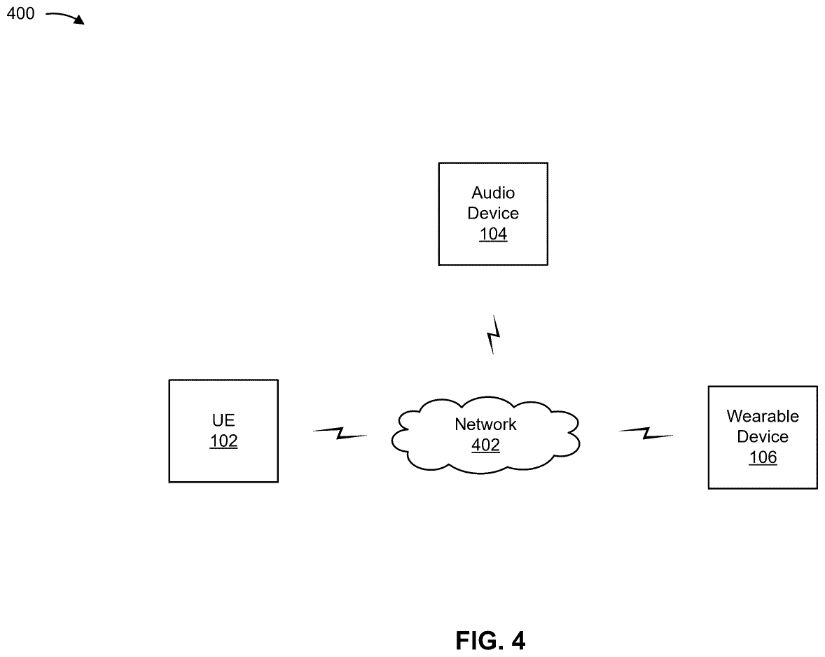

FIG. 4 is a diagram of an example environment 400 in which systems and/or methods described herein may be implemented. As shown in FIG. 4, environment 400 may include a UE 102, an audio device 104, a wearable device 106, and a network 402. Devices of environment 400 may interconnect via wired connections, wireless connections, or a combination of wired and wireless connections.

The UE 102 may include one or more devices capable of receiving, generating, storing, processing, and/or providing information associated with audio playback in the presence of multiple devices, as described elsewhere herein. The UE 102 may include a communication device and/or a computing device. For example, the UE 102 may include a wireless communication device, a mobile phone, a laptop computer, a tablet computer, a desktop computer, a gaming console, a set-top box, a head mounted display, or a virtual reality headset, a smart television, an Internet of Things (IoT) device, or a similar type of device.

The audio device 104 may include one or more devices capable of receiving, generating, storing, processing, and/or providing information associated with audio playback in the presence of multiple devices, as described elsewhere herein. The audio device 104 may include any electronic device that is capable of producing sound. The audio device 104 may include headphones. The headphones may be over-ear headphones (e.g., headset), on-ear headphones, or in-ear headphones (e.g., earbuds). The headphones may be wireless headphones or wired headphones. The audio device 104 may include speakers. The speakers may be wireless speakers (e.g., portable speakers) or wired speakers. The speakers may include smart speakers with voice recognition and other features.

The wearable device 106 may include one or more devices capable of receiving, generating, storing, processing, and/or providing information associated with audio playback in the presence of multiple devices, as described elsewhere herein. For example, the wearable device 106 may be a wearable communication device, such as a smart wristwatch, a pair of smart eyeglasses, a head mounted display, or a virtual reality headset.

The network 402 may include one or more wired and/or wireless networks. For example, the network 402 may include a cellular network (e.g., a Fifth Generation (5G) network, a Fourth Generation (4G) network, a Long Term Evolution (LTE) network, a Third Generation (3G) network, a code division multiple access (CDMA) network, etc.), a public land mobile network (PLMN), a local area network (LAN), a personal area network (PAN) (e.g., a Bluetooth or a BLE based network), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 402 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

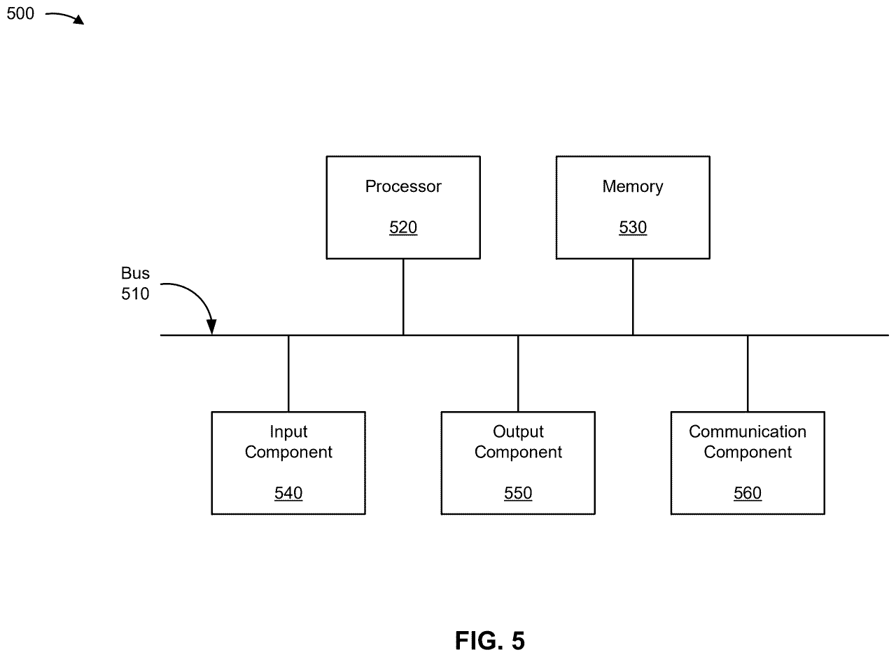

FIG. 5 is a diagram of example components of a device 500 associated with audio playback in the presence of multiple devices. The device 500 may correspond to a UE (e.g., UE 102). In some implementations, the device may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

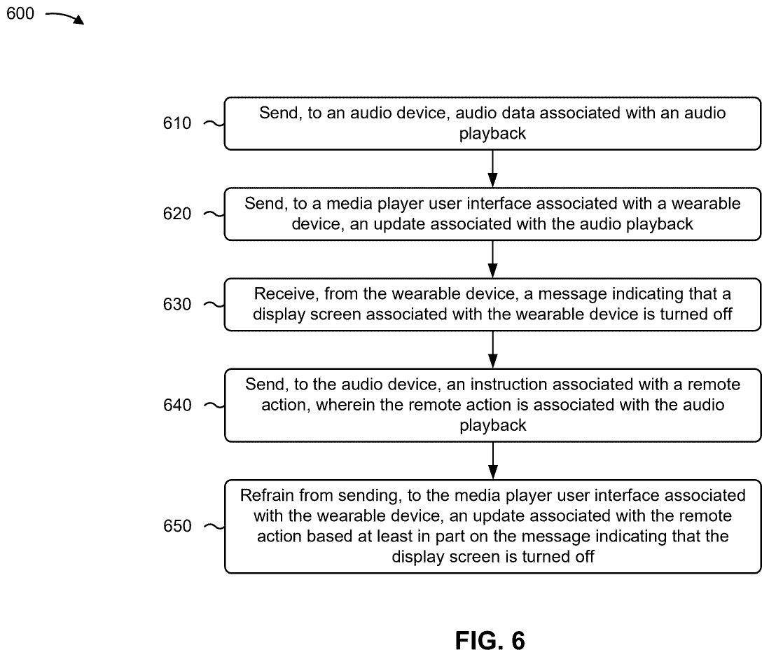

FIG. 6 is a flowchart of an example process 600 associated with audio playback in the presence of multiple devices. In some implementations, one or more process blocks of FIG. 6 may be performed by a device, such as a UE (e.g., UE 102). In some implementations, one or more process blocks of FIG. 6 may be performed by another device or a group of devices separate from or including the device. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include sending, to an audio device, audio data associated with an audio playback (block 610). For example, the UE (e.g., using the one or more components of device 500) may send, to an audio device, audio data associated with an audio playback.

As shown in FIG. 6, process 600 may include sending, to a media player user interface associated with a wearable device, an update associated with the audio playback (block 620). For example, the UE (e.g., using the one or more components of device 500) may send, to a media player user interface associated with a wearable device, an update associated with the audio playback.

As shown in FIG. 6, process 600 may include receiving, from the wearable device, a message indicating that a display screen associated with the wearable device is turned off (block 630). For example, the UE (e.g., using the one or more components of device 500) may receive, from the wearable device, a message indicating that a display screen associated with the wearable device is turned off.

As shown in FIG. 6, process 600 may include sending, to the audio device, an instruction associated with a remote action, wherein the remote action is associated with the audio playback (block 640). For example, the UE (e.g., using the one or more components of device 500) may send, to the audio device, an instruction associated with a remote action, wherein the remote action is associated with the audio playback.

As shown in FIG. 6, process 600 may include refraining from sending, to the media player user interface associated with the wearable device, an update associated with the remote action based at least in part on the message indicating that the display screen is turned off (block 650). For example, the UE (e.g., using the one or more components of device 500) may refrain from sending, to the media player user interface associated with the wearable device, an update associated with the remote action based at least in part on the message indicating that the display screen is turned off.

In a first aspect, the remote action is associated with one of: pausing the audio playback, stopping the audio playback, adjusting a volume associated with the audio playback, or skipping to a next audio track for audio playback.

In a second aspect, alone or in combination with the first aspect, refraining from sending the update avoids the update being processed at the wearable device and the media player user interface being updated in a background when the display screen is turned off.

In a third aspect, alone or in combination with one or more of the first and second aspects, the message indicates a device display status associated with the wearable device.

In a fourth aspect, alone or in combination with one or more of the first through third aspects, the message indicates one bit, and the one bit is set to a first value to indicate that the display screen is turned off or the one bit is set to a second value to indicate that the display screen is turned on.

In a fifth aspect, alone or in combination with one or more of the first through fourth aspects, the message is in accordance with a DCF protocol.

In a sixth aspect, alone or in combination with one or more of the first through fifth aspects, the message is a first message and the remote action is a first remote action, and process 600 further includes receiving, from the wearable device, a second message indicating that the display screen associated with the wearable device is turned on; sending, to the audio device, an instruction associated with a second remote action, wherein the second remote action is associated with the audio playback; and sending, to the media player user interface associated with the wearable device, an update associated with the second remote action based at least in part on the second message indicating that the display screen is turned on.

In a seventh aspect, alone or in combination with one or more of the first through sixth aspects, the audio device is a wireless speaker device and the wearable device is a smart watch.

In an eighth aspect, alone or in combination with one or more of the first through seventh aspects, the UE, the audio device, and the wearable device are associated with an IoT network.

In a ninth aspect, alone or in combination with one or more of the first through eighth aspects, the UE and the audio device are connected via a first Bluetooth connection or a first BLE connection, and the UE and the wearable device are connected via a second Bluetooth connection or a second BLE connection.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:

Aspect 1: An apparatus for wireless communication at a user equipment (UE), comprising: one or more memories; and one or more processors coupled to the one or more memories, the one or more processors individually or collectively configured to cause the UE to: send, to an audio device, audio data associated with an audio playback; send, to a media player user interface associated with a wearable device, an update associated with the audio playback; receive, from the wearable device, a message indicating that a display screen associated with the wearable device is turned off; send, to the audio device, an instruction associated with a remote action, wherein the remote action is associated with the audio playback; and refrain from sending, to the media player user interface associated with the wearable device, an update associated with the remote action based at least in part on the message indicating that the display screen is turned off.

Aspect 2: The apparatus of Aspect 1, wherein the remote action is associated with one of: pausing the audio playback, stopping the audio playback, adjusting a volume associated with the audio playback, or skipping to a next audio track for audio playback.

Aspect 3: The apparatus of any of Aspects 1-2, wherein the update is not sent in order to avoid the update being processed at the wearable device and the media player user interface being updated in a background when the display screen is turned off.

Aspect 4: The apparatus of any of Aspects 1-3, wherein the message indicates a device display status associated with the wearable device.

Aspect 5: The apparatus of any of Aspects 1-4, wherein the message indicates one bit, and wherein the one bit is set to a first value to indicate that the display screen is turned off or the one bit is set to a second value to indicate that the display screen is turned on.

Aspect 6: The apparatus of any of Aspects 1-5, wherein the message is in accordance with a distributed context fabric protocol.

Aspect 7: The apparatus of any of Aspects 1-6, wherein the message is a first message and the remote action is a first remote action, and wherein the one or more processors are individually or collectively configured to cause the UE to: receive, from the wearable device, a second message indicating that the display screen associated with the wearable device is turned on; send, to the audio device, an instruction associated with a second remote action, wherein the second remote action is associated with the audio playback; and send, to the media player user interface associated with the wearable device, an update associated with the second remote action based at least in part on the second message indicating that the display screen is turned on.

Aspect 8: The apparatus of any of Aspects 1-7, wherein the audio device is a wireless speaker device and the wearable device is a smart watch.

Aspect 9: The apparatus of any of Aspects 1-8, wherein the UE, the audio device, and the wearable device are associated with an Internet of Things network.

Aspect 10: The apparatus of any of Aspects 1-9, wherein the UE and the audio device are connected via a first Bluetooth connection or a first Bluetooth Low Energy (BLE) connection, and wherein the UE and the wearable device are connected via a second Bluetooth connection or a second BLE connection.

Aspect 11: A method of wireless communication performed by a user equipment (UE), comprising: sending, to an audio device, audio data associated with an audio playback; sending, to a media player user interface associated with a wearable device, an update associated with the audio playback; receiving, from the wearable device, a message indicating that a display screen associated with the wearable device is turned off; sending, to the audio device, an instruction associated with a remote action, wherein the remote action is associated with the audio playback; and refraining from sending, to the media player user interface associated with the wearable device, an update associated with the remote action based at least in part on the message indicating that the display screen is turned off.

Aspect 12: The method of Aspect 11, wherein the remote action is associated with one of: pausing the audio playback, stopping the audio playback, adjusting a volume associated with the audio playback, or skipping to a next audio track for audio playback.

Aspect 13: The method of any of Aspects 11-12, wherein refraining from sending the update avoids the update being processed at the wearable device and the media player user interface being updated in a background when the display screen is turned off.

Aspect 14: The method of any of Aspects 11-13, wherein the message indicates a device display status associated with the wearable device.

Aspect 15: The method of any of Aspects 11-14, wherein the message indicates one bit, and wherein the one bit is set to a first value to indicate that the display screen is turned off or the one bit is set to a second value to indicate that the display screen is turned on.

Aspect 16: The method of any of Aspects 11-15, wherein the message is in accordance with a distributed context fabric protocol.

Aspect 17: The method of any of Aspects 11-16, wherein the message is a first message and the remote action is a first remote action, and further comprising: receiving, from the wearable device, a second message indicating that the display screen associated with the wearable device is turned on; sending, to the audio device, an instruction associated with a second remote action, wherein the second remote action is associated with the audio playback; and sending, to the media player user interface associated with the wearable device, an update associated with the second remote action based at least in part on the second message indicating that the display screen is turned on.

Aspect 18: The method of any of Aspects 11-17, wherein the audio device is a wireless speaker device and the wearable device is a smart watch, and wherein the UE, the audio device, and the wearable device are associated with an Internet of Things network.

Aspect 19: The method of any of Aspects 11-18, wherein the UE and the audio device are connected via a first Bluetooth connection or a first Bluetooth Low Energy (BLE) connection, and wherein the UE and the wearable device are connected via a second Bluetooth connection or a second BLE connection.

Aspect 20: A non-transitory computer-readable medium storing a set of instructions for wireless communication, the set of instructions comprising: one or more instructions that, when executed by one or more processors of a user equipment (UE), cause the UE to: send, to an audio device, audio data associated with an audio playback; send, to a media player user interface associated with a wearable device, an update associated with the audio playback; receive, from the wearable device, a message indicating that a display screen associated with the wearable device is turned off; send, to the audio device, an instruction associated with a remote action, wherein the remote action is associated with the audio playback; and refrain from sending, to the media player user interface associated with the wearable device, an update associated with the remote action based at least in part on the message indicating that the display screen is turned off.

Aspect 21: A system configured to perform one or more operations recited in one or more of Aspects 1-20.

Aspect 22: An apparatus comprising means for performing one or more operations recited in one or more of Aspects 1-20.

Aspect 23: A non-transitory computer-readable medium storing a set of instructions, the set of instructions comprising one or more instructions that, when executed by a device, cause the device to perform one or more operations recited in one or more of Aspects 1-20.

Aspect 24: A computer program product comprising instructions or code for executing one or more operations recited in one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors coupled to the one or more memories, the one or more processors individually or collectively configured to cause the UE to:
send, to an audio device, audio data associated with an audio playback;
send, to a media player user interface associated with a wearable device, an update associated with the audio playback;
receive, from the wearable device, a message indicating that a display screen associated with the wearable device is turned off;
send, to the audio device, an instruction associated with a remote action, wherein the remote action is associated with the audio playback; and
refrain from sending, to the media player user interface associated with the wearable device, an update associated with the remote action based at least in part on the message indicating that the display screen is turned off.

2. The apparatus of claim 1, wherein the remote action is associated with one of: pausing the audio playback, stopping the audio playback, adjusting a volume associated with the audio playback, or skipping to a next audio track for audio playback.

3. The apparatus of claim 1, wherein the update is not sent in order to avoid the update being processed at the wearable device and the media player user interface being updated in a background when the display screen is turned off.

4. The apparatus of claim 1, wherein the message indicates a device display status associated with the wearable device.

5. The apparatus of claim 1, wherein the message indicates one bit, and wherein the one bit is set to a first value to indicate that the display screen is turned off or the one bit is set to a second value to indicate that the display screen is turned on.

6. The apparatus of claim 1, wherein the message is in accordance with a distributed context fabric protocol.

7. The apparatus of claim 1, wherein the message is a first message and the remote action is a first remote action, and wherein the one or more processors are individually or collectively configured to cause the UE to:
receive, from the wearable device, a second message indicating that the display screen associated with the wearable device is turned on;
send, to the audio device, an instruction associated with a second remote action, wherein the second remote action is associated with the audio playback; and
send, to the media player user interface associated with the wearable device, an update associated with the second remote action based at least in part on the second message indicating that the display screen is turned on.

8. The apparatus of claim 1, wherein the audio device is a wireless speaker device and the wearable device is a smart watch.

9. The apparatus of claim 1, wherein the UE, the audio device, and the wearable device are associated with an Internet of Things network.

10. The apparatus of claim 1, wherein the UE and the audio device are connected via a first Bluetooth connection or a first Bluetooth Low Energy (BLE) connection, and wherein the UE and the wearable device are connected via a second Bluetooth connection or a second BLE connection.

11. A method of wireless communication performed by a user equipment (UE), comprising:
sending, to an audio device, audio data associated with an audio playback;
sending, to a media player user interface associated with a wearable device, an update associated with the audio playback;
receiving, from the wearable device, a message indicating that a display screen associated with the wearable device is turned off;
sending, to the audio device, an instruction associated with a remote action, wherein the remote action is associated with the audio playback; and
refraining from sending, to the media player user interface associated with the wearable device, an update associated with the remote action based at least in part on the message indicating that the display screen is turned off.

12. The method of claim 11, wherein the remote action is associated with one of: pausing the audio playback, stopping the audio playback, adjusting a volume associated with the audio playback, or skipping to a next audio track for audio playback.

13. The method of claim 11, wherein refraining from sending the update avoids the update being processed at the wearable device and the media player user interface being updated in a background when the display screen is turned off.

14. The method of claim 11, wherein the message indicates a device display status associated with the wearable device.

15. The method of claim 11, wherein the message indicates one bit, and wherein the one bit is set to a first value to indicate that the display screen is turned off or the one bit is set to a second value to indicate that the display screen is turned on.

16. The method of claim 11, wherein the message is in accordance with a distributed context fabric protocol.

17. The method of claim 11, wherein the message is a first message and the remote action is a first remote action, and further comprising:
receiving, from the wearable device, a second message indicating that the display screen associated with the wearable device is turned on;
sending, to the audio device, an instruction associated with a second remote action, wherein the second remote action is associated with the audio playback; and
sending, to the media player user interface associated with the wearable device, an update associated with the second remote action based at least in part on the second message indicating that the display screen is turned on.

18. The method of claim 11, wherein the audio device is a wireless speaker device and the wearable device is a smart watch, and wherein the UE, the audio device, and the wearable device are associated with an Internet of Things network.

19. The method of claim 11, wherein the UE and the audio device are connected via a first Bluetooth connection or a first Bluetooth Low Energy (BLE) connection, and
wherein the UE and the wearable device are connected via a second Bluetooth connection or a second BLE connection.

20. A non-transitory computer-readable medium storing a set of instructions for wireless communication, the set of instructions comprising:
one or more instructions that, when executed by one or more processors of a user equipment (UE), cause the UE to:
send, to an audio device, audio data associated with an audio playback;
send, to a media player user interface associated with a wearable device, an update associated with the audio playback;
receive, from the wearable device, a message indicating that a display screen associated with the wearable device is turned off;
send, to the audio device, an instruction associated with a remote action, wherein the remote action is associated with the audio playback; and
refrain from sending, to the media player user interface associated with the wearable device, an update associated with the remote action based at least in part on the message indicating that the display screen is turned off.
